(19) United States
(12) Patent Application Publication
(10) Pub. No.: US 2004/0018482 A1
(43) Pub. Date: Jan. 29, 2004

(54) Loading and unloading of permeating protectants for cell, tissue, and organ cryopreservation by vitrification

(76) Inventor: Victor Bronshtein, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/302,220

(22) Filed: May 8, 2002

Related U.S. Application Data
(63) Continuation of application No. 09/194,397, filed on Mar. 4, 1999, now abandoned.
Application No. 09/194,397 is a 371 of international application No. PCT/US97/09207, filed on May 29, 1997.

(51) Int. Cl. A01N 1/00; A01N 1/02

(52) U.S. Cl. 435/2

(57) ABSTRACT

The present invention is directed to a method for cryopreserving a biological sample, including gradually or stepwise loading the sample with permeating protectant by contacting the sample with solutions including the protectant and a non-permeating co-solute that limits the amount of protectant that penetrates into cells of the biological specimen. The method further includes the gradual or step of unloading (rehydration) of the sample by contacting the sample with one or more rehydration solutions having progressively lower concentrations of both the protectant and co-solute, such that the protectant is removed from the cells of the sample. Concentration of the co-solute during loading and unloading should be at maximum value that still does not damage the sample at room and subzero temperatures.

### 1. FIELD OF INVENTION

The present invention relates to non-toxic loading and unloading of permeating protectants that is required for the cryopreservation of biological specimens (cells and multicellular specimens) by vitrification, or for other purposes.

### 2. BACKGROUND OF THE INVENTION

Conventional low temperature preservation of biological specimens by freezing is not uncommon. However, the strong damaging action of ice crystallization limits application of cryogenic methods to the cryopreservation of cells and multicellular specimens. Vitrification is an alternative approach to cryopreservation that utilizes solidification of samples during cooling, without formation of ice crystals (Fahy et al., 1984). There is currently a need for a reliable method of cell (erythrocyte, stem cells, sperm, etc.) and multicellular, specimens (kidney, heart, etc.) cryopreservation by vitrification. However, the development of these methods was not possible because of several generally accepted misconceptions and deficiencies of the prior art that have been addressed by the inventor (Bronshtein, 1995). The following are some misconceptions and deficiencies of prior art.

### EFFECTS OF DEHYDRATION

Ice formation at low temperatures can be avoided only if samples are sufficiently dehydrated. Dehydration, however, is also known as a common cell damaging factor. The damaging effect of the dehydration increases with increasing concentration of vitrification solution and depends strongly on whether the vitrification solution contains permeating protectants such as dimethylsulfoxide (DMSO), ethylene glycol (EG), propylene glycol, glycerol, etc. For example, cells normally cannot survive equilibration in solutions containing only non-permeating solutes in concentrations greater than 1 mol/1. However, many types of cells can easily tolerate equilibration in solutions containing permeating protectants in much higher concentrations. This is because penetration of protectants protects cells against dehydration damage.

Here, it is important to note that dehydration does not mean decrease in the cell volume, which actually may be very damaging (Marymen, 1967, 1970). The term dehydration means removal of water, or increase in the osmotic pressure. Erroneous use of this term has resulted in several misconceptions. For example, as described below, dehydration by itself is not a strong damaging factor. Dehydration may even be a protective factor, if performed according to the present invention.

Damage of cells during dehydration in concentrated solutions of non-permeating solutes is believed to be caused by hydration forces occurring between biological macromolecules and membranes when distances between them become small as a result of dehydration Bryant and Wolfe (1992). However, it is believed that loading of cells with permeating protectant protects against cell dehydration because intracellular protectant diminishes these forces. Therefore, some amount of intracellular protectants are required to protect cells during dehydration to high osmotic pressures. For this reason, it was proposed (Rall and Fahy, 1985) to equilibrate biological specimens in loading solutions of permeating protectants (dimethyl sulfoxide (DMSO), ethylene glycol (EG), propylene glycol, glycerol, etc.) prior to dehydration, in order to reduce the strong damaging, effect of dehydration. Using this approach, Rall and Fahy (1985) cryopreserved mouse embryos by vitrification. Unfortunately, the protective effect of loading significantly decreases with increasing time of equilibration in vitrification solution containing permeating protectants.

The approach of Rall and Fahy (1985) was successfully applied to a variety of specimens containing a small amount of cells. However, vitrification of larger and more complex specimens (e.g., human kidney, heart, or liver) has not been achieved yet primarily because of the toxic effect of highly concentrated solutions containing permeating protectants. These concentrated solutions are needed to prevent ice formation in complex specimens during cooling and warming. Therefore, one should consider the dependence of cell injury on the time of equilibration in vitrification solution to better understand the mechanism(s) of toxicity. For successful preservation by vitrification, vitrification solution should more effectively diminish both ice formation in the cytosol and extracellular volumes, and toxic effects associated with equilibration (dehydration) of the specimen in concentrated vitrification solution.

Apparent Toxicity of Vitrification Solutions

Based on the general erroneous belief that intracellular protectants help to vitrify cytosol (Bronshtein, 1995), and the fact that some intracellular protectant is required to protect cells during dehydration, penetration of protectant inside cells may be considered as desirable. A negative aspect of this penetration, considered in the literature, is associated with direct chemical toxicity of protectants (Fahy et al., 1990). Because the toxicity is believed to be proportional to the concentration of protectants (not to the amount of protectants inside a cell), three basic approaches have been proposed (for details see review of Steponkus et al., 1992) to minimize the toxicity:

1) to use a mixture of different permeating protectants;

2) to add components that may act as “toxicity neutralizers”; or

3) to identify solutes that will form a glass at lower concentrations.

However, Fahy et al. (1990) found that biochemical studies of the toxicity to date have not met the basic criteria required for demonstrating mechanisms of toxicity. This actually means that the direct chemical toxicity of typical permeating protectants (ethylene glycol, propylene glycol, glycerol and DMSO) is small. The inventor agrees with the conclusion of Fahy et al. (1990) that present concepts of protectant toxicity are in need of serious revision.

Recently, Langis and Steponkus (1990) demonstrated that survival of isolated rye protoplast following the dehydration step is a function of osmolarity rather than the concentration of vitrification solutions. Based on this observation, Steponkus et al. (1992) discussed an alternative strategy for formulating less toxic solutions with lower osmolarity.

As mentioned above, cells can tolerate dehydration in a very concentrated vitrification solution for several minutes if they have been loaded with permeating protectants. However, during longer equilibration times in vitrification solutions, cell survival decreases with increasing time of equilibration. Because loading of cells with permeating protectants protects against the injury that occurs after dehydration in vitrification solution in the case of short dehydration times, one may suggest that the injury depends primarily on osmolarity. However, because the concentration of intracellular protectant that is reached after dehydration increases with increasing osmolarity of vitrification solution, the existing experimental observations do not answer the question whether damage of dehydrated embryos is a result of the increased concentration of intracellular protectant or of the increase in osmotic pressure. In both cases, however, the question as to why the injury increases with dehydration time remains to be answered. It is also very important because the time required to complete dehydration of multicellular specimens can be substantially longer than that for individual cells.

The inventor's observations (Bronshteyn and Steponkus, 1994, Steponkus et al., 1994) suggest that a significant part of the apparent toxicity of ethylene glycol-based vitrification solution for loaded Drosophila melanogaster embryos is associated with ethylene glycol permeation (increase in mass of ethylene glycol inside embryos) rather than with chemical toxicity of intra-embryo ethylene glycol, or osmotic pressure of vitrification solution. The injurious effect of permeation of protectants during equilibration in vitrification solution was also demonstrated in the studies performed with mouse embryos (Zhu et al., 1993; Tachikawa et al., 1993; Kasai et al., 1990). This toxic effect is not related to the increase in intracellular osmotic pressure or biochemical toxicity of protectant because after water efflux from loaded cells, the osmotic pressure and concentration of protectant inside cells is approximately equal to that outside the cells.

The inventor believes (without any intention of being bound by the theory) that the, actual act of permeation of protectants into the cell during loading of high protectant concentrations is a main cause of cell damage that occurs during subsequent unloading.

Kinetics of Protectant Permeation Inside Cells

After the classical work of Kedem and Katchalsky (1958), it was generally accepted that the thermodynamic force responsible for protectant permeation inside cells is proportional to the gradient (across cell membrane) in protectant concentration independent of the composition of vitrification solution. However, the inventor (Bronshteyn and Steponkus, 1994) found that amino acids (glycine and glutamic acid) and carbohydrates (sucrose and sorbitol) significantly diminished ethylene glycol permeation into Drosophila melanogaster embryos. The preventive effect of amino acids was impressive because 1 wt % of glutamic acid +0.5 wt % glycine limited ethylene glycol permeation inside embryos for up to 3 hours of equilibration in vitrification solution containing 42 wt % ethylene glycol. The preventive effect of carbohydrates was about four times smaller. These observations show that the approach of Kedem and Katchalsky (1958) ignored the effect of co-solutes on the chemical potential of protectants. Therefore, the model of Kedem and Katchalsky (1958) and qualitative conclusions obtained based on this model cannot be used to analyze and predict permeation of protectant inside cells during equilibration in a vitrification solution.

Interaction Between Protectants and Proteins

Timasheff (1993) criticized the belief that protectants form some sort of coating (a shell) that protects proteins from denaturation during cryopreservation. His criticism was based on the articles of Gekko and Timasheff (1981), Lee and Timasheff (1981), and other publications reporting that protectants excluded from the surface of proteins. The inventor (Bronshtein, 1995) submitted that the above conclusion of Timasheff and his co-workers is questionable for two reasons. First, the thermodynamic equilibrium in the dialysis experiments of Timasheff and his co-workers cannot be obtained if the hydrostatic pressure inside the dialysis bag is equal to the pressure outside the bag. Further, the suggestion that the effect of this difference in the hydrostatic pressures is negligible is wrong. Second, amino acids limit penetration of protectant into the cell by decreasing the chemical potential of protectant in the extracellular aqueous solution (Bronshteyn and Steponkus, 1994). Therefore, (without any intention of being bound by the theory) protectants adsorb at the surface of proteins and partially replace water molecules hydrating the proteins. The amount of water of hydration, that is replaced by molecules of protectant, at the protein surface increases with increasing concentration of protectant.

Crowe et al. (1990) suggested that freezing and dehydration may be different stress vectors because they found that stabilization of proteins during drying occurs because of an attraction between sugars and proteins. The inventor believes (without any intention of being bound by the theory) that vitrification of the solution (“shell”) at the surface of proteins (and biological membranes) is a general mechanism of protection equally valid for freezing and desiccation.

Effects of Intracellular Protectants on the Stability of Intracellular Amorphous State at Low Temperatures

Steponkus et al. (1992) have shown that decreasing osmolarity of the vitrification solution allows one to decrease the damaging effect of dehydration in vitrification solution if the dehydration time is several minutes or less. However, to obtain cell survival after cryopreservation, one should successfully vitrify both the extracellular solution and the cytosol. For this reason, Steponkus et al. (1992) suggested that the better protectant for the loading step is one that allows stable vitrification of cytosol after dehydration in vitrification solution with lower osmolarity. This suggestion was a reflection of a general belief that the presence of protectants inside cells helps to vitrify cytosol. However, the inventor's recent studies (Bronshtein, in preparation) have shown that vitrification temperature of the maximum freeze dehydrated bovine serum albumin (BSA) solution is Tg=−20° C. In these studies, Tg was estimated as a temperature of detectable onset of ice melting endotherm. Therefore, Tg in protein solutions is much higher than that in solutions of permeating protectants. This suggests that stability of dehydrated cytoplasm, that does not contain protectants, is much higher than that of solutions of permeative protectants with the same osmotic pressure. This agrees with observations (Steponkus et al., 1992; Langis and Steponkus, 1990) obtained for protoplasts from acclimated rye leaves. They found that a protoplast loaded with ethylene glycol must be subjected to greater dehydration than those not loaded with ethylene glycol to achieve maximum survival after storage in liquid nitrogen. The inventors Bronshteyn and Steponkus (1993) found that intraembryo freezing in non-loaded Drosophila embryos after dehydration in vitrification solution occurs at significantly lower temperatures compared to those loaded with 2.125 M ethylene glycol during cooling at 5° C./min. Therefore, contrary to the conventional point of view, addition of low molecular weight protectants into cytoplasm decreases the stability of the cytoplasm.

It is therefore an object of the present invention to provide a non-toxic method for loading (filling in with permeating protectants and simultaneous dehydration) of cells, multicellular tissues, organs, and organisms with high concentrations of permeating protectants (PA) for cryopreservation by vitrification. The method should allow for controlled permeation of protectants into the samples during long-term contact of the samples with the vitrification solution. It is also an object of the present invention to provide a non-damaging cell method for subsequent unloading (washing the PAs out and rehydration) of the PA and reconstituting the preserved biological samples, and to provide a rehydrating solution for use during unloading (rehydration). Both loading and unloading methods, vitrification and rehydration solutions, should allow for superior survival of the cryopreserved sample. These methods and solutions are based on theories that are opposite to the prior art misconceptions described above.

### SUMMARY OF THE INVENTION

The present invention is directed to a method for minimizing toxic effects of loading and unloading biological specimens with permeating protectants. The method includes the steps of loading the sample by contacting the sample with a solution comprising a permeating protectant and a non-permeating co-solute that limits the amount of the protectant that penetrates into cells of the biological specimen. According to the method, decreasing the ability of the protectant to enter cells of the biological specimen is achieved most effectively by adding non-penetrating co-solutes that effectively decrease the chemical potential of permeating protectants in the extracellular solution. The more co-solute that is added, the less amount of protectant penetrates into the cells; however, some minimum amount of protectant inside the cells is required to protect the cells against dehydration. For this reason, the concentration of the co-solutes that can be added is limited. The maximum concentration of co-solutes that can be added to the extracellular solution, to limit penetration of protectant inside cells, depends on the minimum amount of protectant required to protect cells against dehydration. The maximum concentration of co-solutes can be found experimentally for every specific combination of permeating protectants, osmotic pressure of the extracellular solution, and type of co-solute.

The method also includes gradual or stepwise loading (unloading) of permeating protectants with simultaneous increase (decrease) in concentration of permeating protectants and non-permeating co-solutes. For a given concentration of protectants, concentration of non-permeating co-solutes should be the maximum possible concentration that still does not damage cells.

Co-solutes that decrease the chemical potential of penetrating Protectants or protectants in aqueous solutions include, but are not limited to:

1. Amino acids: glycine, alanine, glutamic acid, proline, valine, hydroxy-1-proline, betaaminopropionic acid, aminobutyric acid, beta-aminocaproic acid, aminoisobutyric acid, N-methylglycine, norvaline, and others that are soluble in water in concentration greater than 0.1 mol/l, and derivatives of amino acids (sarcosine, iminodiacetic acid, hydroxyethyl glycine, etc.) that are soluble in water in concentration >0.1 mol/l.

2. Betaines: betaine and other betaines that are soluble in water in concentration greater than 0.1 mol/l.

3. Carbohydrates:

a) Monosaccharides (aldoses and ketoses): glyceraldehyde, lyxose, ribose, xylose, galactose, glucose, hexose, mannose talose, heptose, dihydroxyacetone, pentulose, hexulose, heptulose, octulose, etc., and their derivatives;

b) Amino sugars: D-ribose,3-amino-3-deoxy-, chitosamine, fucosamine, etc.;

c) Alditols and inositols: glycerol, erythritol, arabinitol, ribitol, mannitol, iditol, betitol, inositol, etc.;

d) Aidonic, uronic, and aldaric acids that are soluble in water in concentration >0.1 mol/l; and

e) disaccharides and polysaccharides (sucrose, trehalose, etc.).

4. Sugar alcohols (sorbitol, etc.).

Amino acids most effectively decrease the chemical potential of permeating protectants in aqueous solutions.

The invention allows one to significantly increase concentrations of vitrification solution and the times of loading, cell equilibration in the vitrification solution, and unloading, without increasing cell damage. This allows one to solve many problems occurring during loading of organs with protectants and subsequent cooling by decreasing gradients of osmotic pressure within the sample. This is a very important matter, because if a portion of cells in the sample is less dehydrated it may freeze at low temperatures and be damaged.

Hydration of the cells after cryopreservation and washing out of protectant (unloading) is achieved by equilibration of the specimens (perfusion with, in the case of organs) in solutions of the same protectant with lower osmotic pressures, but still containing the maximum concentration of the co-solutes (amino acids, betaines or carbohydrates) that do not damage cells. The change of concentration during unloading may be gradual or stepwise. This will speed up efflux of protectant and limit the increase of the cell's volume during rehydration. This is an important issue because the increase in cell volume, more than the initial cell volume, may damage the cells.

The statements above reflect the inventor's recent discoveries that protectants preferentially attract to the surface of proteins (Bronshtein, 1995), that amino acids and sugars decrease the chemical potential of glycerol, propylene glycol, ethylene glycol (Bronshteyn and Steponkus, 1994) and other permeating protectants, that the toxicity of protectants increases with increasing mass of protectants inside cells (Bronshtein, 1995), and that stability of the amorphous state inside cells at low temperatures decreases with increasing mass of the protectant inside cells (Bronshtein, 1995).

### BRIEF DESCRIPTION OF THE DRAWING

FIG. 1 shows a plot of the effect of co-solutes on toxicity of 60% ethylene glycol vitrification solution on red blood cells.

### DETAILED DESCRIPTION OF THE PREFERRED EMBODIMENTS

The present invention is directed toward improving low temperature preservation of cells, multicellular specimens and organs by vitrification. To avoid ice formation, samples should be substantially dehydrated. The dehydration damages cells because of large repulsive forces between macromolecules that occur inside cells. A small amount of protectant should be present inside cells in order to decrease these forces. However, the amount of protectant inside the cells should be kept as low as possible to decrease the toxic effect of vitrification solution and to increase the stability of the amorphous state inside the cells at low temperatures. This can be achieved by including non-penetrating co-solutes (amino acids, betaines, sugars, etc.) in the vitrification solution in concentrations from 0.1-0.7 mol/l.

After preservation, the samples should be rehydrated and returned to normal physiological medium. In other words, intracellular protectant should be removed from the cells and exchanged for water. The inventor believes that damage during rehydration occurs because of an increase in cell volume to more, than the initial cell volume, when cells are transferred from vitrification solution to washing, (rehydration) solutions. To avoid this possibility of damage, one has to include in rehydration solutions: amino acids, betaines, carbohydrates, or other non-penetrating, co-solutes that effectively decrease the chemical potential of permeating protectants in aqueous solutions. The co-solutes are used in concentrations from 0.1-0.7 mol/l. Higher co-solute concentrations will more effectively limit the mass of intracellular protectant, however, when this mass gets very small the dehydrated cells may be damaged.

The method for preserving a biological sample comprising the step of loading the sample by contacting the sample with a solution comprising a permeating protectant and a co-solute that decreases the ability of the protectant to enter cells of the biological specimen. The protectant is one of a group of common permeating protectants including, but not limited to, dimethylsulfoxide, ethylene glycol, propylene glycol and glycerol. The co-solute is one of a number of the following classes of compounds including, but not limited to, amino acids and derivatives thereof soluble in water in concentration greater than 0.1 mol/l, betaines soluble in water in concentration greater than 0.1 mol/l, carbohydrates and sugar alcohols, wherein the carbohydrates are selected from the group consisting of aldose monosaccharides, ketose monosaccharides, amino sugars, alditols, inositols, aidonic, uronic and aldaric acids soluble in water in concentrations of greater than 0.1 mol/l, disaccharides and polysaccharides. The total concentration of non-permeating co-solutes in the vitrification solution is preferably between 0.1 and 0.7 mol/l and is equal to a maximum possible concentration that does not damage cells.

The method of the present invention involves both gradual and/or stepwise loading of permeating protectants with simultaneous increase in concentration of permeating protectants and non-permeating co-solutes. The concentration of non-permeating co-solutes should be the maximum possible concentration that still does not damage the biological specimen.

Specifically, the loading step is performed in two or more stages of contacting the sample with increasingly higher concentrations of permeating protectant and co-solute, The loading step is performed by simultaneously increasing concentrations of both the protectant and the co-solute from initial concentrations to final concentrations according to a desired profile. The initial concentration of permeating protectant is zero. The initial concentration of co-solute is preferably zero, but may be greater than zero as long as the co-solute does not damage the sample. The final concentration of co-solute may be determined empirically depending on the nature of the specimen and the choice and concentration of protectant.

The unloading of the protectant can be performed in a gradual or step-wise manner. The only limitation in the profile of the simultaneous increase in protectant and co-solute concentration during loading is that the concentrations of the respective elements remain in an optimal proportion to minimize toxic effect of high concentrations of protectants. The increase in concentration of the protectant and co-solute may be performed manually or mechanically and may be accomplished stepwise or according to a desired profile. The shape of the profile curve may be linear or non-linear, depending upon empirical optimization of the profile for a specific cell type.

Once a biological sample is preserved and stored, it eventually must be rehydrated with the aim of retaining viability of the sample. The rehydration or unloading step is directed to the replacement of protectant in the preserved sample with water. The step of unloading the sample is performed by contacting the sample with a rehydration solution which can be an aqueous solution lacking the protectant (having smaller concentration of the protectant) such that the protectant is removed from the cells of the sample. Preferably, the sample is unloaded in a manner opposite that of the loading step. Specifically, the rehydration solution includes a co-solute and a protectant and the unloading step is performed by simultaneously decreasing concentrations of both the protectant and the co-solute from initial concentrations to final concentrations according to a desired profile. The initial concentrations of both the protectant and the co-solute may be identical to or smaller than the final concentrations thereof, respectively, in the loading process. Preferably, the protectant and the co-solute used during unloading are the same as those used during loading of the same sample.

The protectant and co-solute of the rehydration or unloading solution are selected from the same groups of compounds used in the loading or vitrification solutions. The protectant is one of a group of common permeating protectants including, but not limited to, dimethylsulfoxide, ethylene glycol, propylene glycol and glycerol. The co-solute is one of a number of the following classes of compounds including, but not limited to, amino acids and derivatives thereof soluble in water in concentration greater than 0.1 mol/l, betaines soluble in water in concentration greater than 0.1 mol/l, carbohydrates and sugar alcohols, wherein the carbohydrates are selected from the group consisting of aldose monosaccharides, ketose monosaccharides, amino sugars, alditols, inositols, aidonic, uronic and aldaric acids soluble in water in concentrations of greater than 0.1 mol/l, disaccharides and polysaccharides. The total concentration of non-permeating co-solutes in the unloading solutions is preferably between 0.1 and 0.7 mol/l and is equal to a maximum possible concentration that does not damage cells.

As with the loading step, the unloading step involves both gradual and/or stepwise unloading of permeating protectants with a simultaneous decrease in the concentration of the permeating protectants and non-permeating co-solutes. The initial concentration of non-permeating co-solutes should be the maximum possible concentration that still does not damage the biological specimen.

Specifically, the unloading step is also performed in two or more stages of contacting the sample with increasingly lower concentrations of permeating protectant and non-permeating co-solute. The unloading step is performed by simultaneously decreasing concentrations of both the protectant and the co-solute from initial concentrations to final concentrations according to a desired profile. The initial concentrations of protectant and co-solute is preferably the same as the final concentrations in the loading (vitrification) solution. The final concentration of permeating protectant is zero. The final concentration of co-solute may be greater than zero as long as the co-solute does not damage the sample cells.

The loading of the protectant can be performed in a gradual or stepwise manner. The only limitation in the profile of the simultaneous decrease in protectant and co-solute concentrations during unloading is that the concentrations of the respective elements remain in an optimal proportion to minimize toxicity and to maximize viability on rehydration. The decrease in concentrations of the protectant and co-solute may be performed manually or mechanically and may be accomplished stepwise or according to a desired profile. The shape of the profile curve may be linear or non-linear, depending on empirical optimization of the profile for a specific cell type.

### EXAMPLE 1

Gradual Loading and Unloading of Rat Heart with Dimethylsulfoxide (DMSO).

Materials and Methods

Preparation of the Cardiac Explant: The animal experiments were conducted in accordance with the “Principles of Laboratory Animal Care” formulated by the Institute of Laboratory Animal Resources and the “Guide for the Care and Use of Laboratory Animals” prepared by the Institute of Laboratory Animal Resources and published by the National Institute of Health (NIH Publication No. 86-23, 1985). Male Sprague-Dawley rats (300-350g) were anesthetized with sodium pentobarbital (65 mg/kg, ip) and anticoagulated with heparin (250u, iv). The heart was excised and immediately immersed in ice-cold Krebs-Henseleit buffer (KHB), which contained (in mM): 118 NaCl, 11 glucose, 25 NaHCO₃, 4.7 KCl, 1.2 MgSO₄, 1.2 KH₂PO₄, 0.5 Na-EDTA, and 2.5 CaCl₂. The aorta was cannulated and the heart retrograde perfused at 70 mm Hg for 9 min. with 36.5° C. KHB equilibrated with 95% 0₂/% CO₂. The perfusion was continued for 2 min. at 60 mm Hg with CP-11E saturated with 100% 0₂. The composition of CP-11E (in mM) was: 125 NaCl, 7 glucose, 1.2 KH₂PO₄, 10 mannitol, 15 MgSO₄, 14 KCl, 10 Hepes, 0.02 EDTA, 0.28 CaCl₂ , pH 7.5.

Loading and Removal of DMSO and Mannitol:

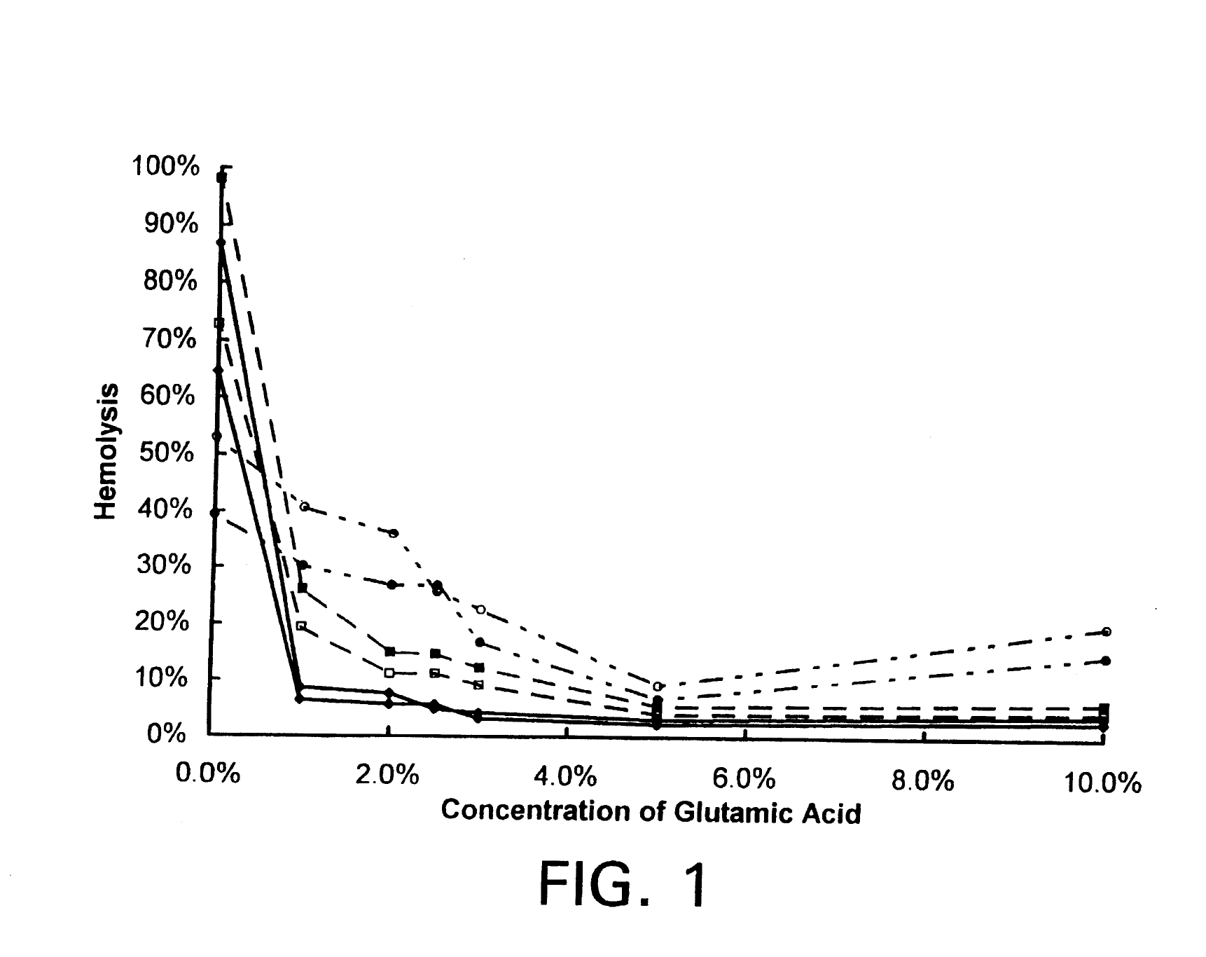

After CP-11E flush, the arrested heart was transferred to a perfusion apparatus (FIG. 1). Both CP-11EB and CP-11E+DMSO+mannitol were bubbled constantly with 100% 0₂. Perfusate was delivered via an aortic cannula by a peristaltic pump at a flow rate of 1 ml/min. Two experiments were performed at room temperature.

Experiment 0: The heart was gradually loaded with 30 wt % DMSO and immediately unloaded. No co-solutes were used. A linear gradient of 0 to 30% DMSO was generated using a gradient maker. DMSO gradient was controlled by the duration of infusion (or the total volume of solution infused). Loading time was 30 min. During the 30 min. loading, the rate of increase in concentration of the solution was 1% DMSO/min. Unloading began right after the end of loading. Unloading time was 60 min. During the 60 min. unloading, a gradient of decreasing DMSO concentration was 0.5 wt %/min.

Experiment 1: The heart was gradually loaded with 30 wt % DMSO and immediately unloaded. A linear gradient of both 0 to 30% DMSO and 0 to 3% mannitol was generated using a gradient maker. DMSO gradient was controlled by the duration of infusion (or the total volume of solution infused). Loading time was 30 min. During the 30 min. loading, the rate of increase in concentration of the solution was 1% DMSO/min. and 0.075% mannitol/min. Unloading began right after the end of loading. Unloading time was 60 min. During the 60 min. unloading, a gradient of decreasing DMSO concentration was 0.5 wt %/min., the final concentration of mannitol was 1 wt %.

Experiment 2: The heart was gradually loaded with 30 wt % DMSO during 30 min, then perfused 30 min. with 30% DMSO +3% mannitol, and then unloaded during 60 min. A linear gradient of both 0 to 30% DMSO and 0 to 3% mannitol was generated using a gradient maker. DMSO gradient was controlled by the duration of infusion (or the total volume of solution infused). During the 30 min. loading, the rate of increase in concentration was 1% DMSO/min. and 0.075% mannitol/min. During the 60 min. unloading, a gradient of decreasing DMSO concentration was 0.5 wt %/min, the final concentration of mannitol was 1 wt %.

Assessment of cardiac function: Cardiac function was assessed by working mode reperfusion with KHB at 11 mm Hg preload and 70 mm Hg after load. Heart rate (HR, beats/min), aortic and coronary flow (AF and CF, ml/min.), cardiac output (CO=AF+CF, ml/min.), systolic and diastolic aortic pressure (mm Hg) were recorded. Coronary vascular resistance and work were calculated according to Neely et al., 1967 (Neely et al. “Effect of Pressure Development on Oxygen Consumption by the Isolated Rat Heart ”. Am. J. Physiology, 212:804-12, 1967).

Results: When mannitol was not present during DMSO loading and unloading (Experiment 0), the heart developed contracture and showed no recovery in function after unloading. With mannitol present during loading, perfusion and unloading, hearts remained soft and recovered substantial function after unloading. Table I shows the recovered cardiac function after DMSO unloading. The results clearly demonstrated that the presence of mannitol prevented damage to the heart caused by exposure to both high concentration of DMSO and extreme changes in extracellular osmotic pressure during loading and unloading.

### EXAMPLE 2

Step Loading and Unloading of Rat Blood with Ethylene Glycol (EG)

Materials and Methods

Blood was sampled from external jugular vein of rats after heart extrusion described in Example 1.

Step loading:

Step 1: 100 μl of blood were mixed with 100 μl of 30 wt % EG+0.9 wt % NaCl. Equilibration time 10 min.

Step 2: 1000 μl of vitrification solution vitrification solution containing mixture of 60 wt % EG+0.9 wt % NaCl with different amounts of glutamic acid monosodium Salt (GA) per gram of Vitrification solution were slowly (during 3-5 min.) added to the mixture obtained after Step 1.

After that the blood cells were equilibrated in Vitrification solution during 60 min. before unloading.

Step Unloading

Step 1: After 60 min. equilibration in vitrification solution erythrocytes were centrifuged down (5 min. at 2000 g), 0.5 ml of supernatant was removed from each sample, and 0.5 ml of 3 wt % GA+0.9 wt % NaCl were added to each sample. Then the samples were mixed by vortexing and equilibrated 10 min.

Step 2: After 10 min. of equilibration, above the erythrocytes were centrifuged down again, then, 0.5 ml of supernatant was removed from each sample, and 0.5 ml of 3 wt % GA+0.9 wt % NaCl were added to each sample. Then the samples were mixed by vortexing and were equilibrated 10 min.

Then erythrocytes were centrifuged down again and 0.5 ml of supernatant was collected from each sample.

Concentration of free hemoglobin in supernatants collected from the samples after equilibration in Vitrification solution, first and second step of unloading was used to characterize the erythrocyte damage (hemolysis). The concentration of free hemoglobin was measured using 390 Turner spectrophotometer (at 550 nm wavelength) after adding 0.5 ml of supernatant to 3 ml of water. The hemolysis was measured as a ratio of hemoglobin concentration in the supernatants to the hemoglobin concentration in the mixture of 41.7 μl of blood with 3.5 ml water that was taken as 100% hemolysis.

The experiment was performed at room temperature. pH of all solutions used in the experiment was 7.0

Results: The dependencies of hemolysis on concentration of GA in vitrification solution after equilibration (solid lines), first (dashed lines) and second step of unloading (dashed—dotted lines) are shown in FIG. 1. From the results presented in FIG. 1, it is seen that addition of co-solutes (GA) protects erythrocytes from damage in Vitrification solution. However, as it was said in the patent description above, the too high concentration of co-solutes may be also damaging.

TABLE 1
The effects of DMSO loading and removal in the presence of mannitol on the function
of the isolated rat heart. Control heart function was established by perfusing freshly
isolated hearts in working mode for 30 min. Function of DMSO-treated hearts was
expressed in real numbers. Recovery was expressed as percentage of control function
and shown in parentheses.

| Exper. | | | | | | | | | |
|---|---|---|---|---|---|---|---|---|---|
| Number | n | HR | AF | CF | CO | SP | DP | WORK | CVR |
| 1 | 1 | 260 | 42.9 | 14.4 | 57.3 | 119 | 73 | 68.8 | 5.07 |
| | | (94%) | (84%) | (59%) | (76%) | (90%) | (118%) | (81%) | (193%) |
| 2 | 1 | 289 | 22.5 | 21 | 43.5 | 96 | 58 | 41.8 | 2.76 |
| | | (104%) | (44%) | (86%) | (58%) | (72%) | (94%) | (49%) | (105%) |
| Control | 8 | 276 | 51.1 | 24.5 | 75.6 | 133 | 62 | 85.0 | 2.64 |
| | | ±18 | ±2.5 | ±1.3 | ±3.0 | ^{±2} | ±3 | ±5.4 | ±0.20 |

References

Bronshtein, V. L. 1995. A heresay about an organ cryopreservation by vitrification. In: “Cryo' 95 program”, Abstract P2-66 of a Paper Presented at the 32nd Annual Meeting of the Society for Cryobiology, Madison, Wis.

Bronshtein, V. L. 1995. Binding, of protectants to the biological macromolecules. In:“Cryo' 95 program”, Abstract P2-65 of a Paper Presented at the 32nd Annual Meeting of the Society for Cryobiology, Madison, Wis.

Bronshteyn, V. L. and Steponkus, P. L. 1994. Amino acids and carbohydrates limit permeation of ethylene glycol in Drosophila melanogaster embryos. In: “Abstract of Papers Presented at the 31st Annual Meeting of the Society for Cryobiology”, Abstract 54, Kyoto, Japan.

Bronshteyn, V. L. and Steponkus, P. L. 1993. Differential scanning calorimeter studies of heterogeneous ice nucleation in Drosophila melanogaster embryos. In: “Abstract of Papers Presented at the 30th Annual Meeting of the Society for Cryobiology”, Abstract 22, Atlanta, Ga.

Bronshteyn, V. L. and Steponkus, P. L. 1992. Differential scanning calorimeter studies of ice formation in Drosophila melanogaster embryos. Cryobiology 29:764-765.(Abstract)

Bryant, G. and Wolfe, J. Interfacial forces in cryobiology and anhydrobiology. Cryo-Letters 13, 23-36, 1992.

Crowe, J. H., Carpenter, J. F., Crowe, L. M. and Anchorodoguy, T. J. (1990). Are freezing and dehydration similar stress vectors? A comparison of modes of interaction of stabilizing solutes with biomolecules, Cryobiology 27: 219-231.

Fahy, G. M., Lilley, T. H., Linsdell, H., St. John Douglas M. and Meryman, H. T. 1990. Protectant toxicity and protectant toxicity reduction: In search of molecular mechanisms. Cryobiology 27:247-268.

Fahy, G. M., MacFarlane, D. R., Angell, C. A. and Meryman, H. T. 1984. Vitrification as an approach to cryopreservation. Cryobiology 21:407-426.

Gekko, K. and Timasheff, S. N. 1981. Mechanism of stabilization by glycerol: Preferential hydration in glycerol-water mixtures. Biochemistry 20: 4667-76.

Langis, R. and Steponkus, P. L. 1990. Cryopreservation of rye protoplasts by vitrification. Plant Physiol. 92:666-671.

Lee, J. C. and Timasheff, S. N. (1981) The stabilization of proteins by sucrose. J. Biol. Chem. 256: 7193-7201

Kasai, M., Komi, J.H., Takakamo, A., Tsudera, H., Sakurai, T. and Machida, T. 1990. A simple method for mouse embryo cryopreservation in a low toxicity vitrification solution, without appreciable loss of viability. J. Reprod. Fertil. 89:91-97.

Kedem, O. and Katchalsky, A. (1958) Thermodynamic analysis of the permeability of biological membranes to non-electrolytes. Biochem. Biophys. Acta 27:229-246.

Meryman, H. T. 1967. The relationship between dehydration and freezing injury in the human, erythrocyte. In: Cellular Injury and Resistance in Freezing Organisms. Vol. II, edited by E. Asahina. pp. 231-244. Institute of Low Temperature Science, Hokkaido University, Sapporo, Japan.

Meryman, H. T. 1970. The exceeding of a minimum tolerable cell volume in hypertonic suspension as a cause of freezing injury. In: The Frozen Cell, edited by G. E. W. Wolstenholme and M. O'Conner. pp. 51-67. J. & A. Churchill, London.

Rall, W. F. and Fahy, G. M. 1985a. Vitrification: A new approach to embryo cryopreservation. Theriogenology 23:220.

Rall, W. F. and Fahy, G. M. 1985b. Ice-free cryopreservation of mouse embryos at −196° C. by vitrification. Nature 313:573-575.

Steponkus, P. L., Bronshteyn, V. L. and Caldwell, Sh. 1994. Cryopreservation of Drosophila melanogaster embryos: Formulation of improved vitrification solutions. In: “Abstract of Papers Presented at the 31st Annual Meeting tcDr of the Society for Cryobiology”, Abstract 51, Kyoto, Japan.

Steponkus, P. L., Langis, R. and Fujikawa, S. 1992. Cryopreservation of plant tissues by vitrification. In: Advances in Low-Temperature Biology, Vol. 1, edited by P. L. Steponkus. pp. 1-61. JAI Press, Ltd., London.

Tachikawa, S., Otoi, T., Kondo, S., Machida, T. and Kasai, M. 1993. Successful vitrification of bovine blastocysts, derived by in vitro maturation and fertilization. Mol. Reprod. Dev. 34:266-271.

Timasheff, S. N. 1993. The control of protein stability and association by weak interaction with water: How do solvents affect these processes Annu. Rev. Biophys. Biolmol. Strict. 22: 67-97.

Zhu, S. E., Kasai, M., Otoge, H., Sakurai, T. and Machida, T. 1993. Cryopreservation of expanded mouse blastocysts by vitrification in ethylene glycol-based solutions. J. Reprod. Fertil. 98:139-145.

I claim:

1. A method for preserving a biological sample, comprising the step of loading the sample with permeating protectants by contacting the sample with a solution comprising a permeating protectant and a non-permeating co-solute that limits the amount the protectant penetrates into the cells of the biological sample.

2. The method for preserving a biological sample as claimed in claim 1, further comprising the step of unloading the sample by contacting the sample with a rehydration solution comprising a solution lacking the protectant such that the protectant is removed from the cells of the sample.

3. The method for preserving a biological sample, as claimed in claim 1 wherein the protectant is selected from the group consisting of dimethylsulfoxide, ethylene glycol, propylene glycol and glycerol.

4. The method for preserving a biological sample as claimed in claim 1, wherein the co-solute is selected from the group consisting of an amino acid and derivatives thereof soluble in water in concentration greater than 0.1 mol/l, a betaine soluble in water in concentration greater than 0.1 mol/l, a carbohydrate and a sugar alcohol, wherein the carbohydrate is selected from the group consisting of an aldose monosaccharide, a ketose monosaccharide, an amino sugar, an alditol, an inositol, aidonic, uronic and aldaric acids soluble in water in concentrations of greater than 0.1 mol/l, disaccharides and polysaccharides.

5. The method for preserving a biological sample as claimed in claim 1, wherein the total concentration of non-permeating co-solutes in the vitrification solution is between 0.1 and 0.7 mol/l and is equal to a maximum possible concentration that does not substantially damage cells.

6. The method for preserving a biological sample. as claimed in claim 4, wherein the co-solute is an amino acid.

7. The method for preserving a biological sample as claimed in claim 1, wherein the loading step is performed in two or more stages of contacting the sample with simultaneously increasing concentrations of the protectant and the co-solute.

8. The method for preserving a biological sample as claimed in claim 1, wherein the loading step is performed by simultaneously increasing concentrations of both the protectant and the co-solute from initial concentrations to final concentrations according to a desired profile.

9. The method for preserving a biological sample as claimed in claim 1, further comprising the step of unloading the sample by contacting the sample with a rehydration solution comprising a non-permeating co-solute and a permeating protectant, the unloading step is performed gradually or stepwise by simultaneously decreasing concentrations of both the protectant and the co-solute according to a desired profile.

10. The method for preserving a biological sample as claimed in claim 9, wherein the co-solute is selected from the group consisting of an amino acid and derivatives thereof soluble in water in concentration greater than 0.1 mol/l, a betaine soluble in water in concentration greater than 0.1 mol/l, a carbohydrate and a sugar alcohol, wherein the carbohydrate is selected from the group consisting of an aldose monosaccharide, a ketose monosaccharide, an amino sugar, an alditol, an inositol, aidonic, uronic and aldaric acids soluble in water in concentrations of greater than 0.1 mol/l, disaccharides and polysaccharides.

11. The method for preserving a biological sample as claimed in claim 1, wherein the loading step is performed at room temperature or higher.

12. A cryopreservation solution for use in cryopreserving biological samples comprising a protectant and a co-solute.

13. The cryopreservation solution as claimed in claim 12, wherein the protectant is selected from the group consisting of dimethylsulfoxide, ethylene glycol, propylene glycol and glycerol.

14. The cryopreservation solution as claimed in claim 12, wherein the co-solute is selected from the group consisting of an amino acid and derivatives thereof soluble in water in concentration greater than 0.1 mol/l, a betaine soluble in water in concentration greater than 0.1 mol/l, a carbohydrate and a sugar alcohol, wherein the carbohydrate is selected from the group consisting of an aldose monosaccharide, a ketose monosaccharide, an amino sugar, an alditol, an inositol, aidonic, uronic and aldaric acids soluble in water in concentrations of greater than 0.1 mol/l, disaccharides and polysaccharides.

15. A rehydration solution for use in rehydrating cryopreserved biological samples comprising a protectant and a co-solute.

16. The rehydration solution as claimed in claim 15, wherein the protectant is selected from the group consisting of dimethylsulfoxide, ethylene glycol, propylene glycol and glycerol.

17. The rehydration solution as claimed in claim 15, wherein the co-solute is selected from the group consisting of an amino acid and derivatives thereof soluble in water in concentration greater than 0.1 mol/l, a betaine soluble in water in concentration greater than 0.1 mol/l, a carbohydrate and a sugar alcohol, wherein the carbohydrate is selected from the group consisting of an aldose monosaccharide, a ketose monosaccharide, an amino sugar, an alditol, an inositol, aidonic, uronic and aldaric acids soluble in water in concentrations of greater than 0.1 mol/l, disaccharides and polysaccharides.

18. The rehydration solution according to claim 17, wherein the cencentration of the co-solute has a maximum value that does not damage the sample at room or subzero temperatures.
